(19) United States
(12) Patent Application Publication
(10) Pub. No.: US 2002/0199010 A1
(43) Pub. Date: Dec. 26, 2002

(54) System, method and computer program for message delivery based on a trend analysis

(76) Inventors: Andy L. Ruse, Riverton, UT (US); Blake A. Sweeten, Lehi, UT (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/891,167

(22) Filed: Jun. 26, 2001

(51) Int. Cl. G06F 15/16

(52) U.S. Cl. 709/232

(57) ABSTRACT

A system, method and computer program for monitoring responses by a user to incoming calls and messages. These responses are time stamped with a time of day and day of week and stored in a database. Once an adequate number of responses have been stored in the database, a statistical trend analysis is performed on the data. This statistical trend analysis generates a trend analysis table for each user which indicates the probability of contacting a user via a specific method for a specific time period and day of the week. Thereafter, whenever an incoming call or message arrives, the trend analysis table is accessed and the location with the highest probability of contact is used for forwarding the incoming call or message to.

### FIELD

The invention relates to a system, method and computer program for message delivery based on a trend analysis. More particularly, the present invention monitors where and how a person may be reached at any given time of the day and day of the week and then forwards all electronic and voice messages to the location and by the mechanism most likely to reach the person.

### BACKGROUND

In the rapid development of computers and communications people can be reached almost anywhere and by many different mechanisms. For example, a person may have one or more cellular telephones, a home phone connected to the local public switched telephone network (PSTN), an office phone connected to a PBX (Private Branch eXchange), and one or more e-mail accounts accessible through the Internet, a local area network (LAN), a wide area network (WAN). Further, many people also have voice mail, a satellite telephone, a pager, fax machines, and wireless application protocol (WAP) capable cellular telephones which allow remote wireless access to the Internet and e-mail accounts. The problem with having so many different ways to contact a person is that it is hard to know where to begin. Should you try the office number first or the cellular phone number? Would it be better to e-mail a message, and if so to which account?

Thus, we are now blessed with to many choices. Methods employed to direct phone calls include call forwarding in which a telephone user may direct incoming phone calls from one phone number to another. Further, a person may specify that phone calls proceed to voice mail automatically. However, if a person fails to designate a number he can be reached at or forgets to change the number when the person changes locations, then phone calls are directed to the wrong place. Further, this does little good for e-mail messages and faxes. Also the person who needs to contacted must always update his location which may be difficult to do all the time.

Therefore, rather than rely on the individual user to tell a system where that person can be reached a system is needed to determine from past response practices where the person is most likely to be reached. Thus, what is needed is a system, method, and computer program that will track incoming voice, e-mail, and faxes along with the manner in which that person responds. Further, what is needed is a system, method and computer program that will time stamp the responses supplied and perform a statistical analysis to determine the method of contact most likely to find the individual.

### BRIEF DESCRIPTION OF THE DRAWINGS

The foregoing and a better understanding of the present invention will become apparent from the following detailed description of exemplary embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto. The spirit and scope of the present invention are limited only by the terms of the appended claims.

The following represents brief descriptions of the drawings, wherein:

FIG. 1 is a systems diagram of an example embodiment of the present invention;

FIG. 2 is a flowchart of the monitoring module software used in an example embodiment of the present invention;

FIG. 3 is a flowchart of the trend analysis module used in an example embodiment of the present invention;

FIG. 4 is a flowchart of the forwarding module software used in an example embodiment of the present invention; and

FIG. 5 is a modular configuration diagram showing the data flow among the software modules used in an embodiment of the present invention.

### DETAILED DESCRIPTION

Before beginning a detailed description of the subject invention, mention of the following is in order. When appropriate, like reference numerals and characters may be used to designate identical, corresponding or similar components in differing figure drawings. Further, in the detailed description to follow, exemplary sizes/models/values/ranges may be given, although the present invention is not limited to the same. As a final note, well-known components of computer networks may not be shown within the FIGs. for simplicity of illustration and discussion, and so as not to obscure the invention.

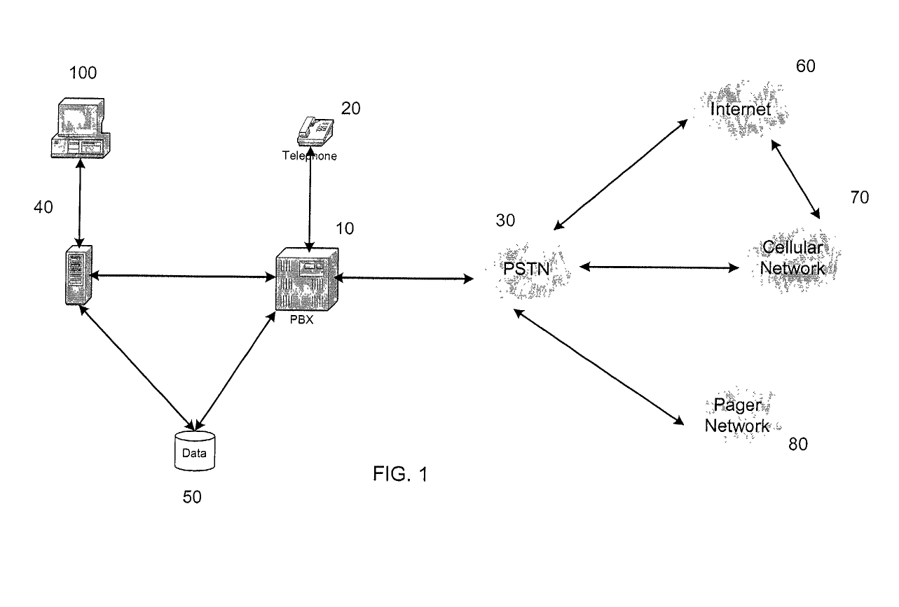

FIG. 1 is a systems diagram of an example embodiment of the present invention. The systems diagram illustrated in FIG. 1 is designed with the typical office environment in mind. A PBX system 10 is utilized to interconnect the telephones 20 in the office as well as providing access to the PSTN 30 for the telephones and the local area network comprising server 40 and several terminals or personal computers (PC) 100. Via the PSTN 30 access to the a pager network 80 or cellular network 70 is also possible as well as to the Internet 60. As would be appreciated by one of ordinary skill in the art is also possible to access the Internet via high-speed coax or fiber-optic cable rather than through the PSTN. In addition, database 50 is provided which may be accessible by either the PBX 10 and/or the server 40. This database 50 would be utilized by the embodiments of the present invention to store the historical and trend analysis data required.

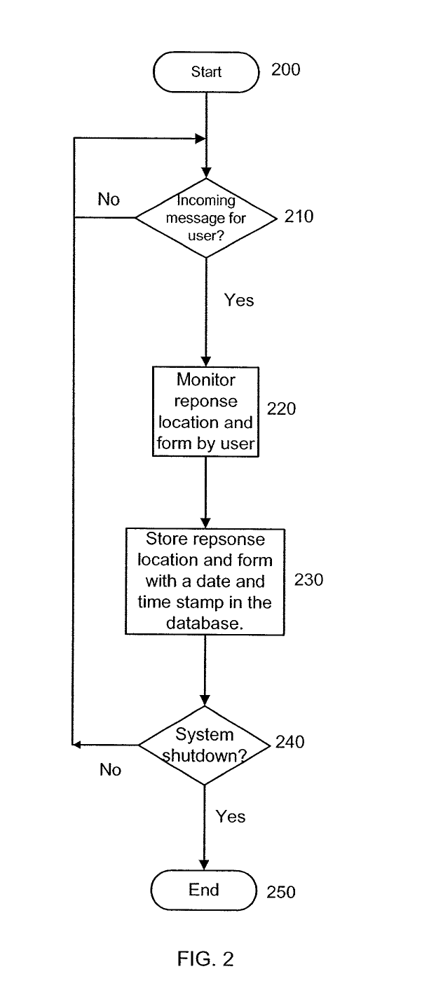

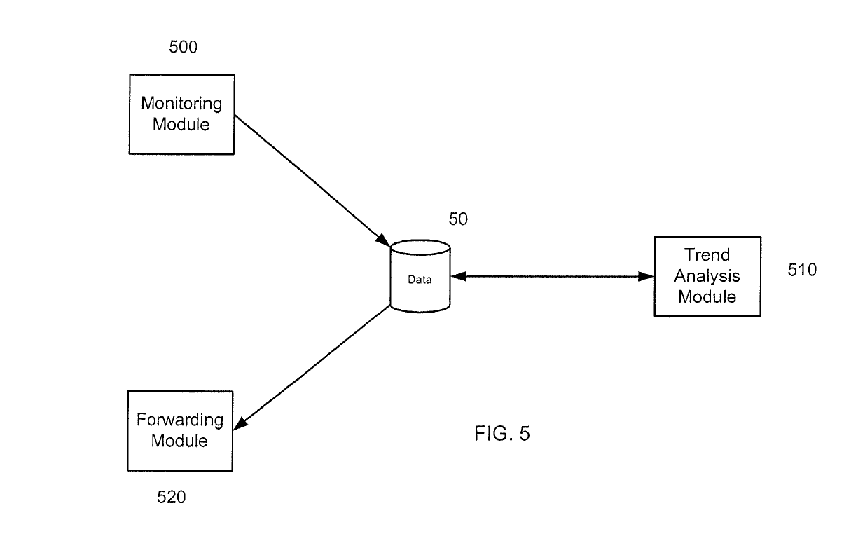

Before proceeding into a detailed discussion of the logic used by the embodiments of the present invention it should be mentioned that the flowcharts shown in FIGS. 2 through 4 as well as the modular configuration diagram shown in FIG. 5 contain software, firmware, hardware, processes or operations that correspond, for example, to code, sections of code, instructions, commands, objects, hardware or the like, of a computer program that is embodied, for example, on a storage medium such as floppy disk, CD Rom, EP Rom, RAM, hard disk, etc. Further, the computer program can be written in any language such as, but not limited to, for example C++. In the discussion of the flowcharts in FIGS. 2 through 4, reference will be simultaneously made to the corresponding software modules shown in FIG. 5. It should further be noted that the logic illustrated in FIGS. 2 through 5 may execute on either PBX 10 or in server 40, shown in FIG. 1.

FIG. 2 is a flowchart of the monitoring module 500, shown in FIG. 5, used in an example embodiment of the present invention. The monitoring module 500 begins execution in operation 200 and immediately proceeds to operation 210. In operation 210, it is determined whether an incoming message has arrived for a user. An incoming message may be in the form of a telephone call, a pager signal, an e-mail, a fax, or any other form of voice, video, or digital data. If no incoming message has arrived then processing loops back to operation 210 until such a message does arrive. However, if such a message does arrive then processing proceeds to operation 220. In operation 220, the response provided by the user to this message is noted along with the time of day, day of the week, and location for the response. Thereafter, in operation 230 the location as well as the time of day and day of week for the response are stored in database 50, shown in FIG. 5. Processing then proceeds to operation 240 where it is determined if the system is to be shut down. If the system is not to be shut down, then processing loops back to operation 210 where the system awaits another incoming message. If the system is to be shut down then processing proceeds to operation 250 where processing terminates.

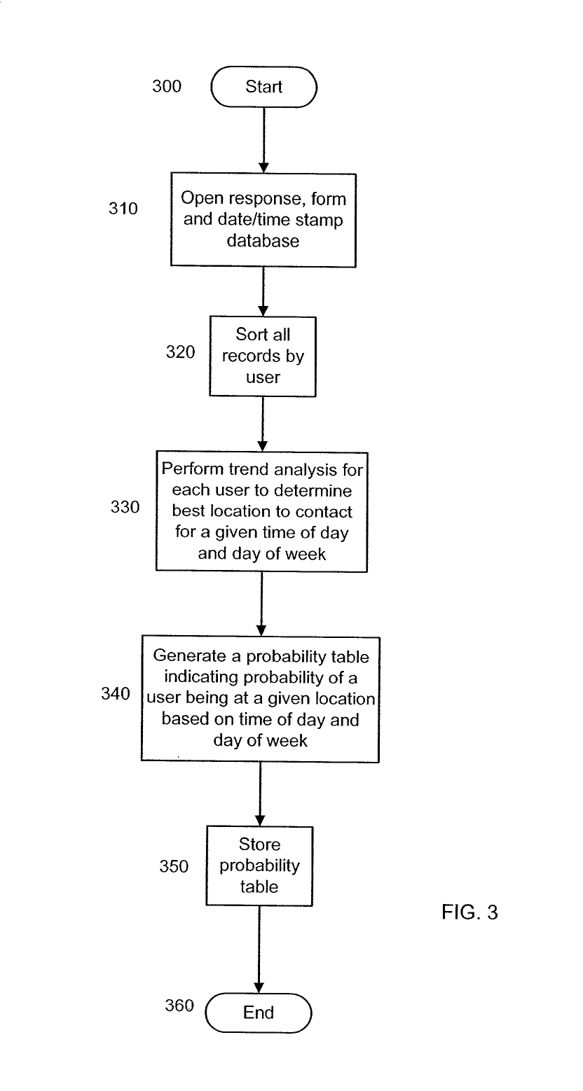

FIG. 3 is a flowchart of the trend analysis module 510, shown in FIG. 5, used in an example embodiment of the present invention. The trend analysis module 510 begins execution in operation 300 and immediately proceeds to operation 310. In operation 310, the response, form and date/time stamp file contained in database 50 is opened. This response, form and date/time stamp file would contain records for all users of the system indicating the form of incoming messages as well as the time and form of response given by the individual user. For example, for a particular user an e-mail message coming in at 10 a.m. on a Monday may be accessed via a WAP capable cellular phone and responded to via that same phone or a personal digital assistant (PDA) attached to the cellular phone. This information for that user would be stored in the response, form and date/time stamp file in database 50. Thereafter, in operation 320 all records in the response, form and date/time file would be sorted by user name or identification. In operation 330, the trend analysis is performed for each user for specific time blocks during the day and specific days of the week. This trend analysis would utilize standard statistical analysis procedures which are well-known in the art to determine the probability of reaching a particular user at a particular time of day on a particular day of the week using the communications methods associated with the user. As previously discussed, these communications methods can be anything from land line telephone numbers, cellular telephone numbers, Internet addresses, pager numbers, fax numbers, e-mail addresses, or any other voice, video, or electronic methods of communications. Once the statistical process completed, processing proceeds to operation 340 where a probability table is generated for each user indicating based on time day and day of week where the user may be reached in order of probability from the highest to the lowest. Thereafter, in operation 350 the probability table is stored within database 50 and processing terminates in operation 360.

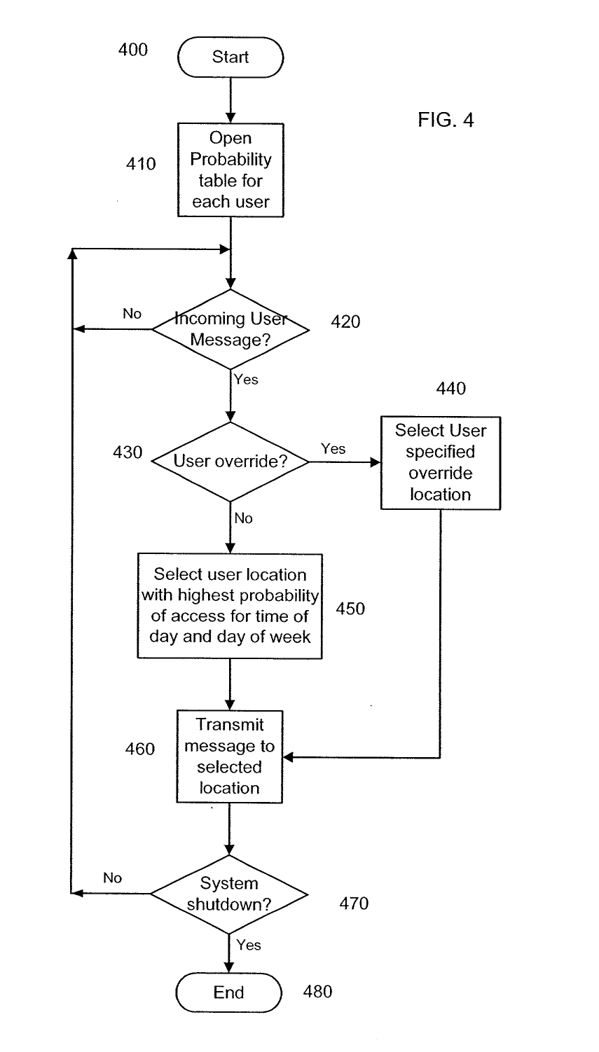

FIG. 4 is a flowchart of the forwarding module 520, shown in FIG. 5, used in an example embodiment of the present invention. The forwarding module begins execution in operation 400 and immediately proceeds to operation 410. In operation 410 the probability tables generated by the trend analysis module 510 are opened for each user. In operation 420, it is determined if incoming user messages have arrived. If no incoming user messages have arrived then the forwarding module 520 loops back to operation 420 until an incoming user message arrives. If an incoming message arrives then processing proceeds to operation 430 where it is determined if the user has specified a location where he may be reached at this point in time. In this manner the user may override the probability table and specify how he may be reached in the case of a change from his normal routine or should he not wish to be disturbed while in some work related activity. If the user has an override specified in operation 430 then processing proceeds to operation 440 where of the incoming message is directed to the location specified by the user. Thereafter, processing proceeds operation 460 where a message is transmitted to the selected location.

Still referring to FIG. 4, however if a user override has not been specified then processing proceeds to operation 450. In operation 450, the probability table for the individual user is opened and the current time and day of the week is looked up in the table. For the current time and day entry there is associated a list of phone numbers and IP addresses at which the user might be located. Each phone number and IP address has a probability associated with it. The phone number or IP address with the highest probability would be selected in operation 450. Thereafter, processing would proceed to operation 460 where the message would be sent to the selected location. In operation 470 it is determined whether a system shutdown is desired. If a system shutdown is not desired then processing loops back to operation 420 where the forwarding module waits for another incoming message. Otherwise, if a system shutdown is desired, processing then proceeds operation 480.

FIG. 5 is a modular configuration diagram showing the data flow among the software modules used in an embodiment of the present invention and as previously discussed in reference to FIGS. 2 through 4. The monitoring module 500, previously discussed in reference to FIG. 2, is used to receive and monitor incoming messages and responses so that the database 50 may contain the response patterns for a particular user based on time of day and day of week. The trend analysis module 510, previously discussed in reference to FIG. 3, does the statistical analysis of the data provided by the monitoring module 500 and stored in the database 50 in order to create a trend analysis table for each user. The forwarding module 520 would access the trend analysis table for each user upon receiving an incoming message and determine where to transmit that message based on the probability of receiving response.

The benefit resulting from the present invention is that a simple, reliable, system and method is provided so that a user does not have to specifying where he may normally be reached. Instead the system determines the most likely locations for locating the user based upon past history.

While we have shown and described only a few examples herein, it is understood that numerous changes and modifications as known to those skilled in the art could be made to the example embodiment of the present invention. One change that is possible to the present system deals with the tracking of incoming messages and responses based on the source as well as the time of day and day of week. Such analysis by the trend analysis module 510 may serve to indicate that with certain callers the user prefers responding by e-mail rather than phone. Thus, a separate field may be contained in the trend analysis table specifying a caller identification and associated preferred mechanism of responding to the particular caller. Another change to the system would entail proceeding to the next highest probability contact point for the user where the first attempt is deemed to be unsuccessful. Thus, the present invention may proceed from highest to lowest probability contact points if such a process is desired by the caller. Therefore, we do not wish to be limited to the details shown and described herein, but intend to cover all such changes and modifications as are encompassed by the scope of the appended claims.

We claim:

1. A method for forwarding messages, comprising:
monitoring locations of responses to incoming messages along with the time of day and day of week;
storing each response along the associated time of day and day of week in a database;
performing a statistical trend analysis on a user bases to determine a probability of contacting the user for a given time of day and day of week at a given location;
storing in a trend analysis table the result of the statistical trend analysis performed; and
transferring incoming messages to the location in the trend analysis table with the highest probability of contacting the user.

2. The method recited in claim 1, wherein said trend analysis table comprises a user identification, a plurality of times of day and days of week with locations of contact and probabilities of successful contact associated with each location.

3. The method recited in claim 2, wherein said trend analysis table further comprises a user override location that indicates probabilities of successful contact for each location are to be ignored and only the override location is to be used for contact.

4. The method recited in claim 3, wherein the incoming messages and responses are from PSTN telephone, cellular telephone, pager, fax, voice mail, e-mail or other voice or digital communication format.

5. The method recited in claim 4, further comprising:
checking the user override location in the trend analysis table; and
transmitting the incoming message to the user override location when set.

6. The method recited in claim 4, further comprising:
contacting the user at the location with the highest probability of successful contact associated with the location;
contacting the user at the location with the second highest probability of success when unable to contact the user at the location with the highest probability of success.

7. A system for forwarding messages, comprising:
a monitoring module to monitor responses by users to messages received and store the location of the response with a time stamp in a database;
a trend analysis module to perform a statistical probability analysis on the location and time stamp data in the database and determine the probability of contacting the user at each of a plurality of locations for a given time of day and storing the probability of contacting the user at each of a plurality of locations in a trend analysis table; and
a forwarding module to receive an incoming message and forward the incoming message to a location with the highest probability of contacting the user as designated in the trend analysis table.

8. The system recited in claim 7, wherein the database further comprises:
a trend analysis table having a user identification, a plurality of times of day and days of week with locations of contact and probabilities of successful contact associated with each locations.

9. The system recited in claim 8, wherein said trend analysis table further comprises a user override location that indicates probabilities of successful contact for each location are to be ignored and only the override location is to be used for contact.

10. The system recited in claim 9, wherein the responses monitored by the monitoring module are provided in response to incoming messages, said incoming messages and responses are from PSTN telephone, cellular telephone, pager, fax, voice mail, e-mail or other voice or digital communication format.

11. The system recited in claim 10, wherein the forwarding module checks an override location specified by a user and forwards all incoming messages to the override location.

12. The system recited in claim 10, wherein the forwarding module will attempt to contact the user at the location in the trend analysis table with the highest probability of contact and proceed to contact the at the location with the second highest probability of contact when the contacting the user at the location with the highest probability of contact fails.

13. A computer program for forwarding messages, comprising:
monitoring locations of responses to incoming messages along with the time of day and day of week;
storing each response along the associated time of day and day of week in a database;
performing a statistical trend analysis on a user bases to determine a probability of contacting the user for a given time of day and day of week at a given location;
storing in a trend analysis table the result of the statistical trend analysis performed; and
transferring incoming messages to the location in the trend analysis table with the highest probability of contacting the user.

14. The computer program recited in claim 13, wherein said trend analysis table comprises a user identification, a plurality of times of day and days of week with locations of contact and probabilities of successful contact associated with each location.

15. The computer program recited in claim 14, wherein said trend analysis table further comprises a user override location that indicates probabilities of successful contact for each location are to be ignored and only the override location is to be used for contact.

16. The computer program recited in claim 15, wherein the incoming messages and responses are from PSTN telephone, cellular telephone, pager, fax, voice mail, e-mail or other voice or digital communication format.

17. The computer program recited in claim 16, further comprising:
checking the user override location in the trend analysis table; and
transmitting the incoming message to the user override location when set.

18. The computer program recited in claim 16, further comprising:
contacting the user at the location with the highest probability of successful contact associated with the location;
contacting the user at the location with the second highest probability of success when unable to contact the user at the location with the highest probability of success.
